(19) United States
(12) Patent Application Publication
(10) Pub. No.: US 2009/0183782 A1
(43) Pub. Date: Jul. 23, 2009

(54) PRESSURE RELIEF VALVE WITH SINGULAR BODY

(76) Inventor: Francis J. Martin, Huntington, NY (US)

Correspondence Address: F. CHAU & ASSOCIATES, LLC, 130 WOODBURY ROAD, WOODBURY, NY, 11797, US

(21) Appl. No.: 12/017,265

(22) Filed: Jan. 21, 2008

(51) Int. Cl. F16K 11/00; B23P 11/00

(52) U.S. Cl. 137/244; 29/428

(57) ABSTRACT

A pressure relief valve includes a singular body and a poppet, within the singular body. The popper is forced into a seated position against a seat by a spring, wherein the seat is fit into the singular body.

### BACKGROUND OF THE INVENTION

1. Technical Field

The present disclosure relates to a relief valve and, more specifically, to a pressure relief valve with a singular body.

2. Discussion of the Related Art

A relief valve is a type of valve used to control an amount of fluid pressure in a system. When pressure in the system rises to a predetermined level, the relief valve will open to allow the pressurized fluid to flow from an auxiliary passage out of the system. By releasing the pressurized fluid when the predetermined pressure is reached or exceeded, the system may be protected against excessive pressure. Accordingly, relief valves may be used to ensure that system pressure does not exceed design limits.

A relief valve may include a spring bearing against a poppet. The spring provides a closing force on the poppet to maintain the valve in the closed position. Once the predetermined pressure level is achieved, the poppet is unseated and opens to create a passage through which the pressurized fluid can escape from the system. The unseating of the poppet compresses the spring. When the fluid pressure is sufficiently reduced, the spring pushes the poppet back into the closed position closing off the fluid's passage of escape.

FIG. 1 is a schematic diagram illustrating a conventional relief valve. The relief valve 10 may include a fluid inlet 11 within a body portion 12. Fluid in the inlet 11 presses against a poppet 13, which when in the closed position, may be at least partially within the body 12. The fluid presses against the poppet 13 with a pressure equal to the system pressure. A spring 14 provides a closing force against the poppet 13 such that the poppet 13 will remain in the closed position as long as the system pressure does not exceed the closing force of the spring 14. The spring 14 may push against a stationary shim 18. The poppet 13 is contained within a seat 15 and the seat 15 may allow the fluid to escape through an outlet 16 when the poppet 13 is in the open position. The spring 14 may be within a housing 17. The poppet 13 may at least partially enter the housing 17 when in an open position.

The body 12, the seat 15 and the housing 17 together form a body structure that confines the pressurized fluid. The seat 15 may be welded to both the body 12 and the housing 17 to confine the fluid. The welding may be performed using a brazing process. Alternatively, the seat 15 may be welded to the body 12 by an electron beam welding process and the seat 15 may be welded to the housing 17 by a laser tack welding process.

While modern welding techniques may be quite effective, the possibility still exists that leakage may occur at the welding points. This may be especially true for relief valves operating in high-pressure systems. Moreover, welding can add significantly to the complexity and cost of relief valve manufacture.

### SUMMARY

A pressure relief valve includes a singular body and a poppet, within the singular body. The popper is forced into a seated position against a seat by a spring, wherein the seat is fit into the singular body.

The pressure relief valve may further include a shim located within the singular body proximate to the spring for holding an end of the spring stationary with respect to the singular body. The shim may be held in place relative to the singular body by a retainer. The seat may be interference fit into the singular body. The singular body may be temporarily expanded with heat prior to interference fitting the seat into the singular body.

The seat may include a stepped region on its outer surface and the singular body may include a complementary stepped region on its inner surface such that when the seat is fit into the singular body, the interface between the stepped region of the seat and the complementary stepped region of the singular body limits movement of the seat.

A pressure relief valve includes a singular body, a shim, that is immovably secured within the singular body, a spring, within the singular body, that is at one end proximate to the shim and at another end proximate to a poppet, and a seat that is fit into the singular body for receiving the poppet.

The shim may be immovably secured within the singular body by a retainer. The seat may include a stepped region on its outer surface and the singular body may include a complementary stepped region on its inner surface such that when the seat is fit into the singular body, the interface between the stepped region of the seat and the complementary stepped region of the singular body limits movement of the seat.

The seat may be interference fit into the singular body. The singular body may be temporarily expanded with heat prior to interference fitting the seat into the singular body.

A method for assembling a pressure relief valve includes inserting a spring and a poppet into a singular body and fitting a seat for receiving the poppet into the singular body.

The seat may be interference fit into the singular body. The singular body may be temporarily expanded with heat prior to interference fitting the seat into the singular body. A shim, along with a retainer, may be inserted into the singular body after the spring is inserted and the spring is proximate to the shim. The shim may be held in place relative to the singular body by the retainer.

The seat may include a stepped region on its outer surface and the singular body may include a complementary stepped region on its inner surface such that when the seat is fit into the singular body, the interface between the stepped region of the seat and the complementary stepped region of the singular body limits movement of the seat.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a schematic diagram of a conventional pressure relief valve as seen in the related art;

FIG. 2 is a schematic diagram illustrating a pressure relief valve having a singular body according to exemplary embodiments of the present invention; and

FIG. 3 is a flow chart illustrating a method for assembling a pressure relief valve having a singular body according to exemplary embodiments of the present invention.

### DETAILED DESCRIPTION OF THE DRAWINGS

In describing the exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention provide a pressure relief valve having a singular body including an inlet and an outlet, and enclosing a poppet, a seat, and a spring without the need for welding. Accordingly, pressure relief valves according to exemplary embodiments of the present invention may be more resistant to leaks and may be less expensive to manufacture than conventional pressure relief valves.

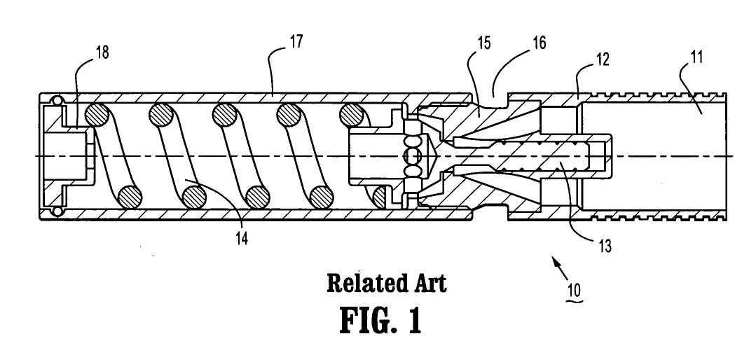

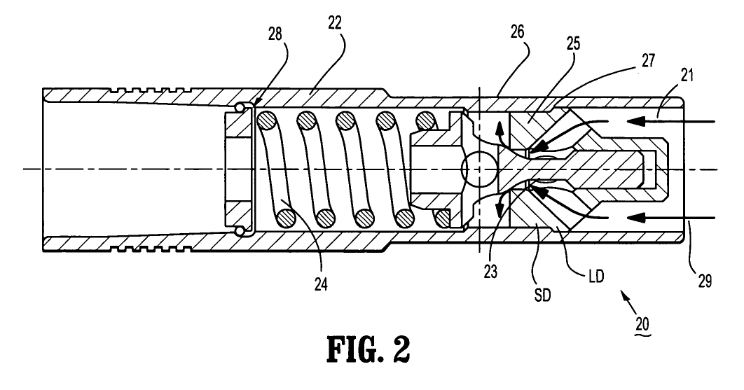

In conventional pressure relief valves, for example, as shown in FIG. 1, the seat 15 may be positioned between the housing 17 and the body 12. Exemplary embodiments of the present invention may implement a singular body by press fitting the seat into the body, for example, as described in detail below with respect to FIG. 2.

FIG. 2 is a schematic diagram illustrating a pressure relief valve having a singular body according to exemplary embodiments of the present invention. The pressure relief valve 20 may have a singular body 22. A spring 24 may be located within the singular body 22 to provide an axial closing force against a poppet 23. The spring 24 may push against a shim 28 that may also be enclosed within the singular body 22. The shim 28 may fit against other valve components, for example, a retainer 38. The poppet 23 may also be enclosed within the singular body 22. When forced into a closed position by the spring 24, the poppet 23 presses against a seat 25 and thus prevents fluid, such as oil, from flowing through the outlet 26. The seat 25 may also be enclosed within the singular body 22. The seat 25 may be interference fit inside the singular body 22, for example, as shown in FIG. 2. With the interference fit, the diameter of the seat 25 is larger than the inner diameter of the body 22 to create a tight fit that prevents leakage.

Thus, interference fit is a fastening between two parts, here the seat 25 and the singular body 22, which is achieved by friction after the parts have been pushed together. Interference fitting may also be known as press fitting, indicating that pressure is often used as a method for placing the seat within the singular body. In addition to the application of pressure, the diameter of the singular body may be temporarily expanded, for example, with the application of heat, to more easily allow for the insertion of the seat into the singular body.

In addition, the body 22 and the seat 25 include a stepped portion 27 from a larger diameter area LD to a smaller diameter SD. The stepped portion 27 further prevents the seat 25 from moving into the body 22 (in the left-hand direction in FIG. 2) when under pressure from the inlet 21.

Fluid may then enter the pressure relief valve 20 through the inlet 21 and press against the poppet 23, for example, as shown by the fluid path arrows 29.

Accordingly, when the fluid pressure exceeds a desired pressure, the force of the spring 24 is overcome and the poppet 23 is moved away from the seat 25 (unseated) thus allowing the fluid to escape through the outlet 26, for example, as shown by the fluid path arrows 29. When in normal operation, the release of fluid may reduce the fluid pressure until the force of the spring 24 is again able to push the poppet 23 against the seat 25 thereby closing off the flow of fluid through the outlet 26. Accordingly, the pressure relief valve may be used to limit the maximum fluid pressure in the system.

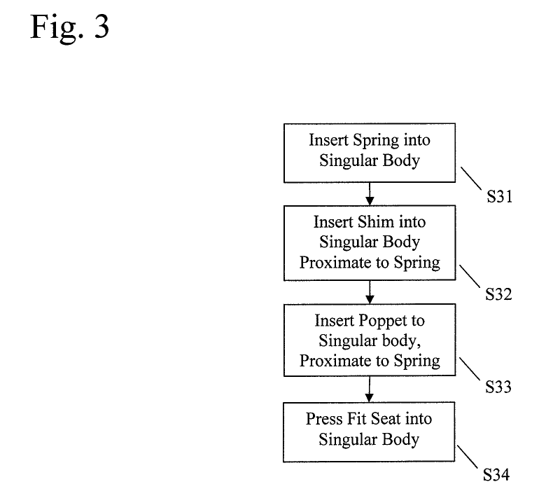

Assembly of the single-bodied pressure relief valve may be performed as described with reference to FIG. 3. A spring may be inserted into a singular pressure relief valve body (Step S31). A shim may then be inserted into the singular body proximate to the spring (Step S32). The shim may be inserted along with a retainer. A poppet may then be inserted into the singular body proximate to the spring (Step S33). A seat may then be inserted into the singular body (Step S34). The seat may be press fit and/or interference fit into the singular body such that it may remain immobile with respect to the singular body.

When fit into the singular body, the seat may be pressed such that a stepped region of the seat fits tightly against a complementary stepped region of the inner surface of the body. As such, when fit, potential motion of the seat towards the spring is prevented.

Accordingly, the pressure relief valve may be assembled within a singular body and without the need to perform welding.

Pressure relief valves so assembled may have a reduced fabrication cost, may be more reliable and may have a reduced risk of leakage over conventional pressure relief valves.

The above specific exemplary embodiments are illustrative, and many variations can be introduced on these embodiments without departing from the spirit of the disclosure or from the scope of the appended claims. For example, elements and/or features of different exemplary embodiments may be combined with each other and/or substituted for each other within the scope of this disclosure and appended claims.

What is claimed is:

1. A pressure relief valve, comprising:
a singular body; and
a poppet, within the singular body, that is forced into a seated position against a seat by a spring, wherein the seat is fit into the singular body.

2. The pressure relief valve of claim 1, further comprising a shim located within the singular body and proximate to the spring for holding an end of the spring stationary with respect to the singular body.

3. The pressure relief valve of claim 2, wherein the shim is held in place relative to the singular body by a retainer.

4. The pressure relief valve of claim 1, wherein the seat is interference fit into the singular body.

5. The pressure relief valve of claim 4, wherein the singular body is temporarily expanded with heat prior to interference fitting the seat into the singular body.

6. The pressure relief valve of claim 1, wherein the seat includes a stepped region on its outer surface and the singular body includes a complementary stepped region on its inner surface such that when the seat is fit into the singular body, the stepped region of the seat and the complementary stepped region of the singular body interface with each other.

7. A pressure relief valve, comprising:
a singular body;
a shim, that is immovably secured within the singular body;
a spring, within the singular body, that is at one end proximate to the shim and at another end proximate to a poppet; and
a seat that is fit into the singular body for receiving the poppet.

8. The pressure relief valve of claim 7, wherein the shim is immovably secured within the singular body by a retainer.

9. The pressure relief valve of claim 7, wherein the seat includes a stepped region on its outer surface and the singular body includes a complementary stepped region on its inner surface such that when the seat is fit into the singular body, the stepped region of the seat and the complementary stepped region of the singular body interface with each other.

10. The pressure relief valve of claim 7, wherein the seat is interference fit into the singular body.

11. The pressure relief valve of claim 10, wherein the singular body is temporarily expanded with heat prior to interference fitting the seat into the singular body.

12. A method for assembling a pressure relief valve, comprising:
inserting a spring and a poppet into a singular body; and
fitting a seat for receiving the poppet into the singular body.

13. The method of claim 12, wherein the seat is interference fit into the singular body.

14. The method of claim 13, wherein the singular body is temporarily expanded with heat prior to interference fitting the seat into the singular body.

15. The method of claim 12, wherein a shim is inserted into the singular body after the spring is inserted and the spring is proximate to the shim.

16. The method of claim 15, wherein the shim is held in place relative to the singular body by a retainer.

17. The method of claim 12, wherein the seat includes a stepped region on its outer surface and the singular body includes a complementary stepped region on its inner surface such that when the seat is fit into the singular body, the stepped region of the seat and the complementary stepped region of the singular body interface with each other.
